(19) United States
(12) Patent Application Publication
(10) Pub. No.: US 2004/0262274 A1
(43) Pub. Date: Dec. 30, 2004

(54) Novel laser diamond sawing machine

(76) Inventor: Arvindbhai L. Patel, Ahmedabad (IN)

Correspondence Address: FOLEY AND LARDNER, SUITE 500, 3000 K STREET NW, WASHINGTON, DC, 20007, US

(21) Appl. No.: 10/488,866

(22) PCT Filed: Oct. 14, 2002
(86) PCT No.: PCT/IN02/00208

(30) Foreign Application Priority Data
Feb. 21, 2002 (IN) 166/MUM/2002

(51) Int. Cl. B23K 26/00

(52) U.S. Cl. 219/121.68

(57) ABSTRACT

A NOVEL LASER DIAMOND SAWING MACHINE is a non-contact very fast process of cutting the diamond compared to conventional process. This machine consists of Laser source, CNC Interface, Beam delivery system, RF Q-Switch driver. Chiller unit, CCTV & CCD camera. Power supply unit, Servo Stabilizer and Computer unit. The sawing occurs automatically by commands of computer. To avoid errors, simultaneously the process is seen on the CCTV. By this twin side sawing system 6-9 dies containing diamond can be processed. This is very fast, time saving mass processing machine.

### TECHNICAL FIELD

The present invention relates to A NOVEL LASER DIAMOND SAWING MACHINE.

Since the period of epics, it is found that diamonds are not new for Indian society. One ton digging gives only one carat diamond. These raw diamonds are being assorted as Jewellery and industrial grade. Jewellery stones are then further assorted for kerfing, sawing and direct marketable stone.

### BACKGROUND ART

Sawing is a process to cut a diamond into two parts along with the intended line. According to state of art the raw diamond is fixed on plate and sawing is accomplished be a saw—a paper—thin disc of phosphor bronze, rotated on a horizontal spindle at about 4000 rpm. along the marking. In this process the cutting force spreads to other parts of the diamond which may damage the diamond and also by this process there can not be a precise straight cutting.

Laser sawing is a non-contact very fast process of cutting the diamond compared to conventional process. The present invention system consists of following parts;

1. Laser source

2. CNC Interface

3. Beam delivery system

4. RF Q-Switch driver

5. Chiller unit

6. CCTV & CCD camera

7. Power supply unit

8. Servo Stabilizer

9. Computer unit

### DISCLOSURE OF THE INVENTION

The present invention will be described with greater specific and clarity with reference following drawings:

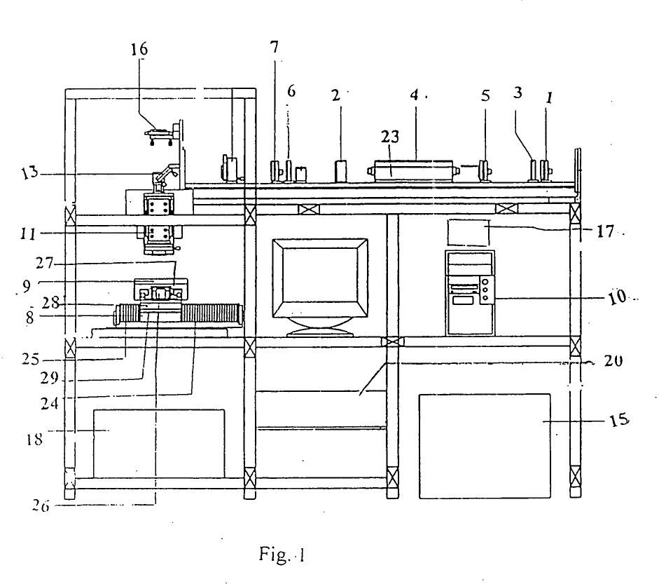

FIG. 1. represents the block diagram of the laser sawing machine.

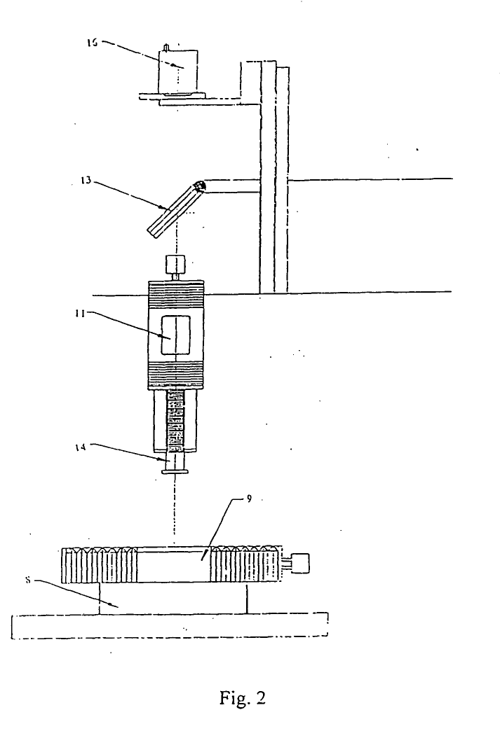

FIG. 2. represents layout of the machine showing parts of the machine

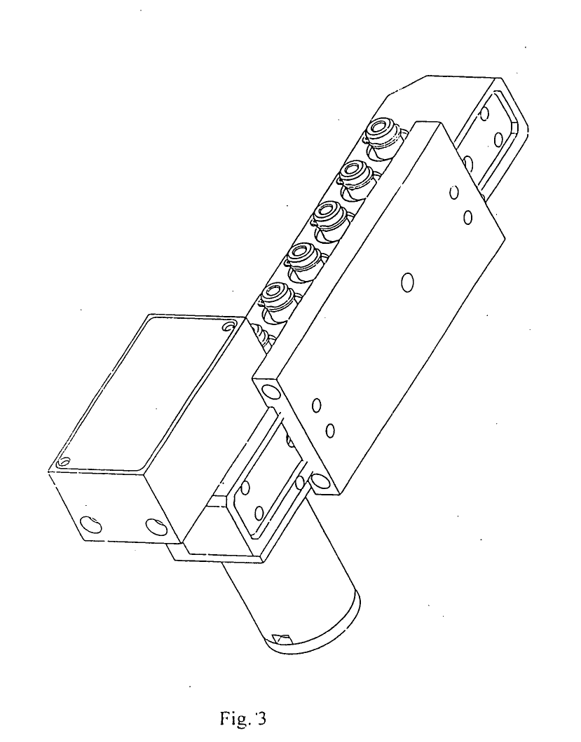

FIG. 3. represents sawing assembly and fixture

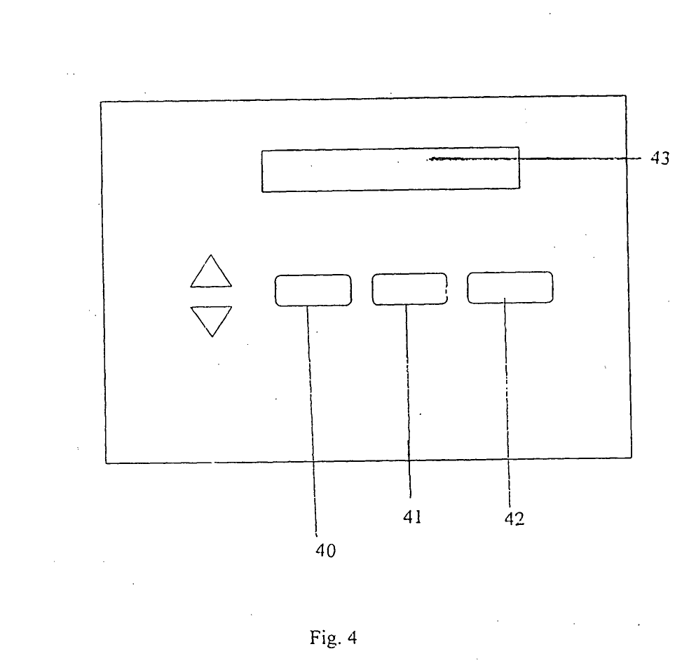

FIG. 4. represents lay out of RF Q switch driver

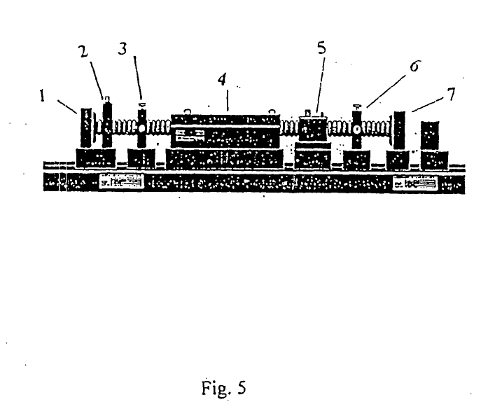

FIG. 5. represents resonator

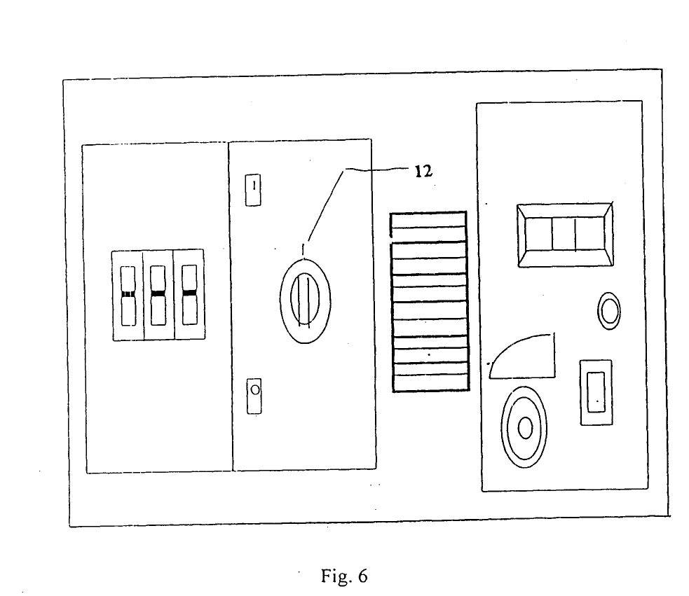

FIG. 6. represents layout of power supply assembly

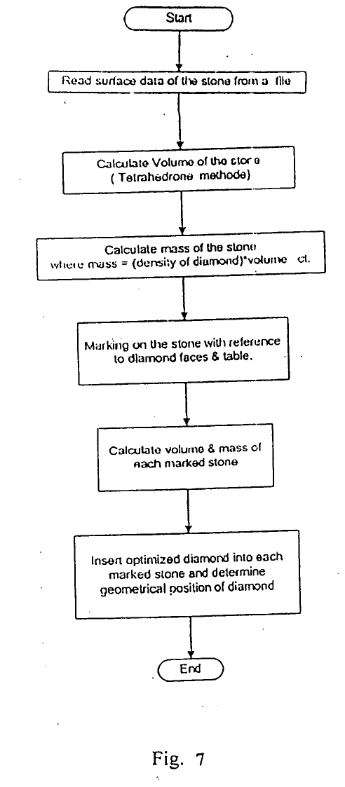

FIG. 7. represents a flow chart of processing module

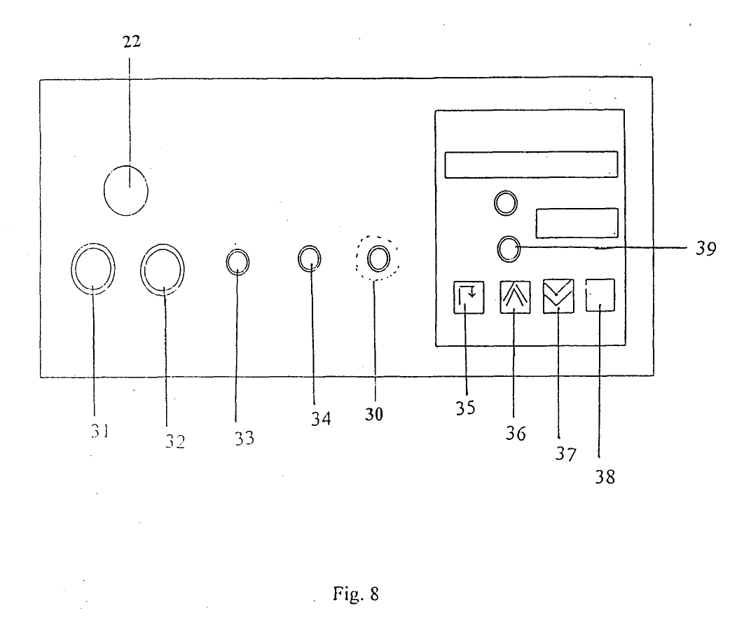

FIG. 8. represents a cooling unit

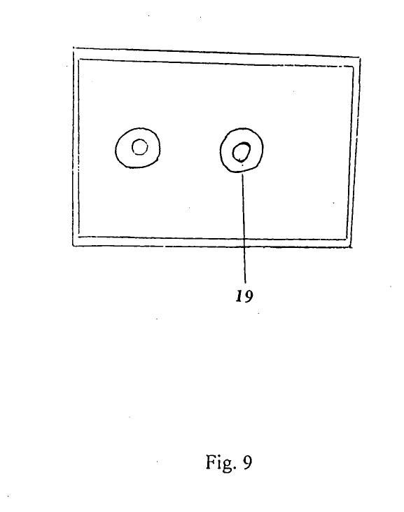

FIG. 9. represents a CNC Interface

Laser source unit/resonator (FIG. 5) has a laser head 4, a Q-switch 5, two apertures 3 & 6, front mirror 1 & back mirror 7, a safety Shutter 2, and a beam expander. Laser head 4 is the crucial part to generate the laser light. Front and back mirror 1 & 7 amplifies the laser light by providing the feedback. Q-switch 5 is used to store the laser light energy to emit as a burst of high peak power. Shutter 2 block the laser beam in case of electrical failure and hence it is called as a safety shutter. An aperture 3 & 6 controls the light amplification along the off-axis of the resonator FIG. 5 to provide the sharp frequency band. As per the name indicates, beam expander 13 expands the laser beam to minimize its divergence.

CNC Interface consists of X 8 or Y 9 or Z 11 axis and the computer unit 10. For this purpose, inside the computer 10, a control card is placed which is connected to the rear portion of the accupos 18 having a 37-pin connector/parallel port. A beam attenuator—safety shutter 2 must be provided which will enable user to terminate lasing without turning off the main power switch 12. The safety shutter 2 is located inside the laser head assembly 4 and is actuated by the toggle switch 19. The shutter 2 terminates lasing by blocking the laser beam path and preventing emission of laser radiation out of the head assembly 4.

Beam delivery system consists a beam bender 13 and a focusing lens 14. The laser beam coming from the beam expander of the laser source is to be sent to the work-surface. Beam bender 13 bends the beam at 90° which is then focused by the focusing lens 14. By changing the focal length of focusing lens 14, power density and depth of the focus can be altered. The alignment of the focus is very important because if the beam center does not co-inside with center of the lens then the beam after the lens will not be straight and therefore the cutting efficiency drastically decreased.

RF Q-Switch driver to get the pulsed output with high peak power, the laser is operated in Q-switched mode 5. To get the radio frequency RF generator 20 is used. Due to this high frequency it is also cooled by chilled water by chilling unit 21.

Chiller unit is used for two purpose;

(1) three phase chiller system which is used for providing the chilled water to the laser head 4 and Q-switch 5.

(2) Pump system 22 which is mainly used for circulating the water from chiller to the laser head via water to water heat exchanger 15.

Inside laser cavity 23 both Nd:YAG rod and the lamp are immersed in flowing cold water. The De-ionized water is used as it has high transparency and low electrical conductivity. Water temperature is regulated by means of a solenoid 30 CCD camera 16 gives 75 times magnification for on-line viewing the process. And this process can be seen on CCTV 17 to avoid errors.

Power supply unit ignites and controls the intensity of the laser light emitted by the laser lamp. This is the main power supply unit which controls the laser output. In many application laser is not used continuously, therefore the power supply is provided with a special feature of standby mode. This arrangement is very much useful in increasing the operational life of lamp and also that of power supply.

Servo Stabilizer prevents the whole machine from the variations of the electricity supply.

Computer unit is provided with standard hardware and special software as shown in FIG. 7 Twin Side Sawing (TSS) 28 is an assembly with a provision to place 6-6 dies on both the sides having two sensor—one is sensing forward direction 24 and another is sensing backward direction 25. This assembly is also provided with limit switches with screw adjustment for precise setting of 180 degree for double side sawing.

TSS Fixture 29 is to Move TSS 28 upto 180 degree by software command with the help of fixture's motor. Laser head 4 is the most important component to produce the laser light. This head 4 consists rod and lamp. Rod is made of Nd:YAG and it works as a pumping source to produce more photons. These photons fall on lamp of Krypton which ultimately produce laser light. Two mirrors 1 & 7 are placed at each end of laser chamber—FIG. 5 to amplify the laser light by feedback mechanism. Power supply controls the intensity of beam. Beam expander 13 reduces the divergence and improves directionality of the beam, making the beam thin and parallel. Q-switch 5 produces a powerful pulse from the continuous beam. An aperture 3 & 6 restricts the light amplification along the axis of laser chamber and thus provides sharp frequency band. Beam coming out from the laser source is bended at 90 degree to reach to the diamond. Then through focusing lens 14, beam gets focused on the diamond. Through computer card, movement of the axes can be controlled. In case of power failure a safety shutter blocks the laser beam.

In cooling unit 31 is a switch, 32 is start switch, 33 is flow switch, 34 is low water level switch, 35,36,37 & 38 are temperature setting switches and 39 is alarm switch.

In RF Q Switch driver 40 is mode switch, 41 is enter switch, 42 is power switch and 43 is start switch.

When TSS 28 filled with dies with 12 mm distance between each die is placed on the fixture and the machine is switched on first computer, starts with “Shortcut to Multi sawing” icon. When this icon is double clicked, on screen, “set diamond data” is seen containing options like: center point, start point, end point, focus point, size of diamond, step size, saw width, minimum width and start at. After entering all the relative data and then clicking on “start sawing” all the data are displayed on the screen. If any particular diamond is to skip then parameters are set for the next diamond. To stop the sawing process press “escape”.

Speed setting, extra setting, axes setting, fixture setting, key direction, step size, ramping, shutter on/off etc. are done by selection from appropriate advance setup.

1. A NOVEL LASER DIAMOND SAWING MACHINE consists of Laser source, CNC Interface, Beam delivery system, RF Q-Switch driver, Chiller unit, CCTV & CCD camera, Power supply unit, Servo Stabilizer and Computer unit.

2. A NOVEL LASER DIAMOND SAWING MACHINE as claimed in claim 1 wherein laser source unit consists of laser head, a Q-switch, an aperture, front & back Mirror, Shutter, and a beam expander.

3. A NOVEL LASER DIAMOND SAWING MACHINE as claimed in claim 1 wherein Q-switch is used to store the laser energy to emit as a burst of high peak power.

4. A NOVEL LASER DIAMOND SAWING MACHINE as claimed in claim 1 wherein an aperture controls the light amplification along the off-axis of the resonator.

5. A NOVEL LASER DIAMOND SAWING MACHINE as claimed in claim 1 wherein beam expander expands the laser beam to minimize its divergence.

6. A NOVEL LASER DIAMOND SAWING MACHINE as claimed in claim 1 wherein CNC Interface consists of X or Y or Z axis and the computer unit.

7. A NOVEL LASER DIAMOND SAWING MACHINE as claimed in claim 1 wherein inside the computer a control card placed to control the movement of the axes.

8. A NOVEL LASER DIAMOND SAWING MACHINE as claimed in claim 1 wherein a control card connected to the rear portion of the accupos having a 37-pin connector/parallel port.

9. A NOVEL LASER DIAMOND SAWING MACHINE as claimed in claim 1 wherein beam delivery system consists a beam bender and a focusing lens.

10. A NOVEL LASER DIAMOND SAWING MACHINE as claimed in claim 1 wherein beam bender bends the beam at 90° which is then focused by the focusing lens.

11. A NOVEL LASER DIAMOND SAWING MACHINE as claimed in claim 1 wherein RF Q-Switch driver is to get the pulsed output with high peak power.

12. A NOVEL LASER DIAMOND SAWING MACHINE as claimed in claim 1 wherein three phase chiller system which is used for providing the chilled water to the laser head and Q-switch.

13. A NOVEL LASER DIAMOND SAWING MACHINE as claimed in claim 1 wherein in the chiller unit pump system which is mainly used for circulating the water from the chiller to the laser had via water to water heat exchanger.

14. A NOVEL LASER DIAMOND SAWING MACHINE as claimed in claim 1 wherein the chiller unit De-ionized water used.

15. A NOVEL LASER DIAMOND SAWING MACHINE as claimed in claim 1 wherein CCD camera gives 75 times magnification and can be seen on CCTV.

16. A NOVEL LASER DIAMOND SAWING MACHINE as claimed in claim 1 wherein the main power supply unit which controls the laser output.

17. A NOVEL LASER DIAMOND SAWING MACHINE as claimed in claim 1 wherein 6-6 dies are placed together on twin side sawing.

18. A NOVEL LASER DIAMOND SAWING MACHINE as claimed in claim 1 wherein twin side sawing has two sensors on both the sides—one sensing forward direction and another sensing backward direction.

19. A NOVEL LASER DIAMOND SAWING MACHINE as claimed in claim 1 and wherein the twin side sawing assembly provided with limit switches.

20. A NOVEL LASER DIAMOND SAWING MACHINE as claimed in claim 1 wherein TSS Fixture fixes TSS.

21. A NOVEL LASER DIAMOND SAWING MACHINE as claimed in claim 1 wherein TSS Fixture move TSS upto 180 degree.

22. A NOVEL LASER DIAMOND SAWING MACHINE as claimed in claim 1 wherein the computer program is substantially described in flow chart in accompanying FIG. 7.

23. A NOVEL LASER DIAMOND SAWING MACHINE substantially herein described with reference to the foregoing description and the accompany drawings.

24. A NOVEL LASER DIAMOND SAWING MACHINE as claimed in claim 2 wherein Q-switch is used to store the laser energy to emit as a burst of high peak power.

25. A NOVEL LASER DIAMOND SAWING MACHINE as claimed in claim 2 wherein an aperture controls the light amplification along the off-axis of the resonator.

26. A NOVEL LASER DIAMOND SAWING MACHINE as claimed in claim 6 wherein inside the computer a control card placed to control the movement of the axes.

27. A NOVEL LASER DIAMOND SAWING MACHINE as claimed in claim 6wherein a control card connected to the rear portion of the accupos having a 37-pin connector/parallel port.

28. A NOVEL LASER DIAMOND SAWING MACHINE as claimed in claim 7 wherein a control card connected to the rear portion of the accupos having a 37-pin connector/parallel port.
